(19) United States
(12) Patent Application Publication
(10) Pub. No.: US 2003/0179286 A1
(43) Pub. Date: Sep. 25, 2003

(54) System for distributing television programmes and for carrying out communications services, as well as central unit of a distribution system, communications terminal, plug-in board for a computer and connection unit

(75) Inventors: Dietrich Bottle, Salach (DE); Heinz-Georg Krimmel, Korntal-Munchingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/384,644

(22) Filed: Mar. 11, 2003

(30) Foreign Application Priority Data
Mar. 21, 2002 (EP) 02360097.6

(51) Int. Cl. H04N 7/14

(52) U.S. Cl. 348/14.02

(57) ABSTRACT

The invention relates to a system for distributing television programmes with a television distribution system operated like a radio broadcast and at least one cable distribution system for connecting a plurality of television sets, with a central unit connecting the distribution system to the television distribution system, to which, for carrying out communications services, at least one cell of a cellular radio communications service belongs, which is connected to the central unit of the distribution system via a connection unit, as well as a central unit of a distribution system, a communications terminal, a plug-in board for a computer and a connection unit.

### BACKGROUND OF THE INVENTION

The invention is based on a priority application EP 02360097.6 which is hereby incorporated by reference.

The invention relates to a system for distributing television programmes, a central unit of a distribution system, a communications terminal for connecting to a cable distribution system in the system, a plug-in board for a computer for connecting to a cable distribution system and a connection unit for connecting to a cable distribution system. The invention further relates to a system with a cable distribution system and a central unit terminating the distribution system at the end remote from the subscriber and a central unit of a distribution system with at least one connector for a cable distribution system.

There currently exists a multiplicity of systems for distributing television programmes to the aerial sockets of consumers. At the end near the consumer these systems have a cable distribution system with a central unit. The cable distribution system is in the simplest case a coaxial cable with an aerial socket connected to the end. This cable can also be looped in advance through other aerial sockets. Further, spur lines with further aerial sockets can branch off from this cable. Several of such cables can even be connected in parallel to the central unit.

The central unit is in the simplest case a connection box for connecting to a terrestrial outdoor aerial. As a rule, in this case several outdoor aerials are connected, which serve to receive all locally available television programmes. A satellite aerial device is frequently also connected.

The distribution system is at its widest configuration level the distribution system of a large community aerial system which overall represents a large tree network. The core of a large community aerial system of this kind (the “root” of the “tree”) is in that case a head station which is equipped with aerials for both terrestrially receivable television programmes and television programmes broadcast via satellites and perhaps also takes on the distribution of television programmes distributed via cable. As a rule at least frequency conversion of individual programmes also therein takes place, in order to make optimal use of the distribution system and yet to exclude mutual interference. For reasons of capacity, not because of basic considerations, in this case, however, the invention should be applied to individual branches rather than to the entire tree. In this case either the head station itself, with only low load, or else the various house or apartment building distributors act as central unit. Here interconnection can also take place between several owners or users of the overall system. A point of this kind is conventionally designated as an interconnection point.

Conditional both on the sharp increase in the use of the internet and also on the opening of the communications network to free bidders, the desire, and also requirement, to be able to use the existing distribution systems for bidirectional communications services too is continually increasing.

### SUMMARY OF THE INVENTION

The object of the invention is to supplement cable distribution systems in such a way that they can also be used for bidirectional communications services.

This object is achieved according to the invention by a system for distributing television programmes with a television distribution system operated like a radio broadcast and at least one cable distribution system for connecting a plurality of television sets, with a central unit connecting the distribution system to the television distribution system, wherein at least one cell of a cellular radio communications service is connected to the central unit of the distribution system via a connection unit, for carrying out communications services, a central unit of a distribution system with a connection for a television distribution system and at least one connection for a cable distribution system for connecting a plurality of television sets, wherein the central unit has a switching unit which is suitable for feeding signals from and for an connection unit of a cellular radio communications service, in addition to the signals of the television distribution system, into the cable distribution system or to extract them from it, a communications terminal for connecting to a cable distribution system in the system according to claim 1, wherein the communications terminal has a format converter for separating signals of a cellular radio communications service., a plug-in board for a computer for connecting to a cable distribution system in the system according to claim 1, wherein the plug-in board has a format converter for separating signals of a cellular radio communications service and a connection unit for connecting to a cable distribution system in the system according to claim 1, wherein the connection unit has a format converter for separating signals of a cellular radio communications service and further a protocol converter for converting the signals of a cellular radio communications service into signals of a wire-bound communications service, in particular into ISDN or DSL signals.

A connection unit of a cellular radio communications service is connected to the central unit of a distribution system (house distribution system, community aerial system). In this way communications services at a lower level are tsmitted via cable, while at a level above this there is radio transmission with point-to-multipoint property.

Based on this, it has been recognized that if there is sufficient capacity for the communications services, these can also take on the provision of television programmes, whereby the television distribution system and the components and modules specially required for them are no longer needed.

From this there results a system with a cable distribution system and a central unit terminating the distribution system at the end remote from the subscriber, wherein a cell of a cellular radio communications service is connected to the central unit of the distribution system via a connection unit and a central unit of a distribution system with at least one connection for a cable distribution system, wherein a network termination unit is part of the central unit, wherein the network termination unit together with a radio termination unit represents a connection unit of a cellular radio communications service.

Further configurations of the invention can be seen in the subordinate claims and the following description.

### BRIEF DESCRIPTION OF THE DRAWINGS

The invention is further explained below with the aid of the connected drawings.

FIG. 1 shows a system according to the invention for distributing television programmes and for carrying out communications services with central units and connections according to the invention for communications terminals according to the invention.

### DETAILED DESCRIPTION OF THE DRAWINGS

FIG. 2 shows a cable distribution system with a central unit according to the invention, a communications terminal according to the invention, a computer with a plug-in board according to the invention and an connection unit according to the invention.

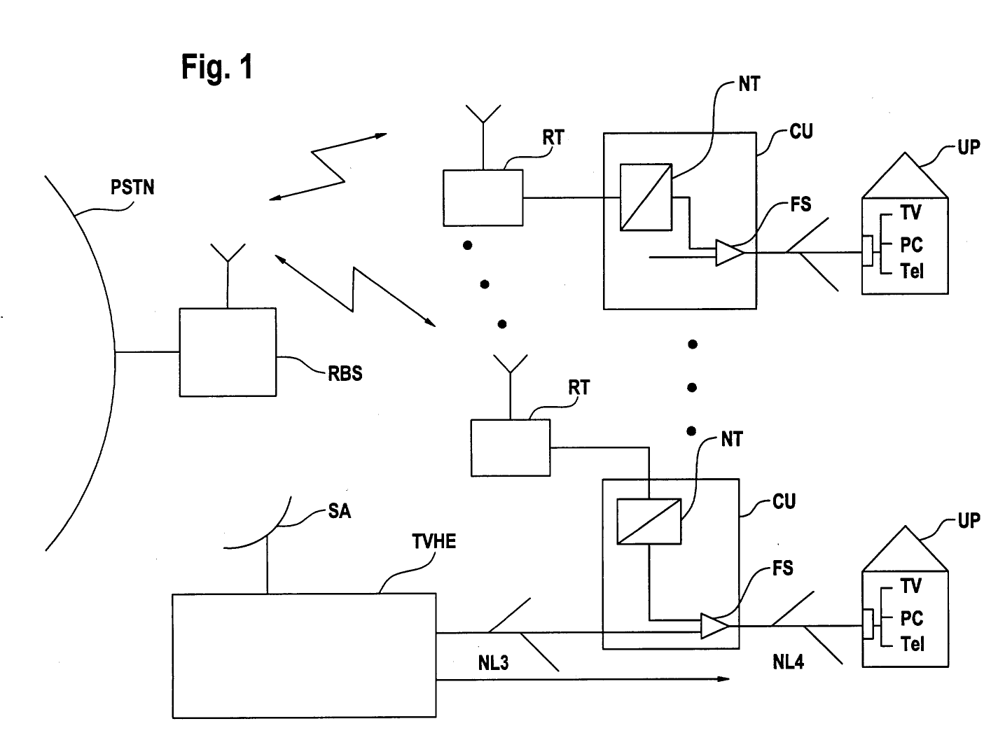

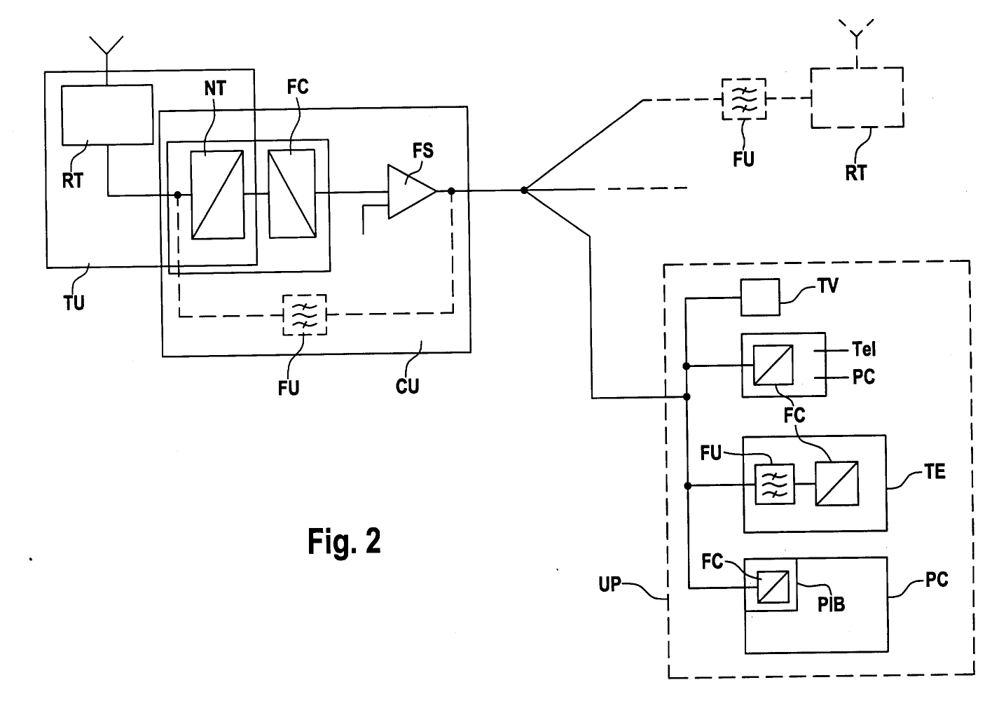

FIG. 1 shows a public communications network CN, a radio base station RBS, two radio network termination units RT, two central units CU, the premises UP of two consumers, and also a television head station TVHE with a satellite aerial system SA. The central units CU each have a network termination unit NT and a frequency separating filter FS. The premises UP of a consumer each have a connection box, not designated in greater detail, and a smaller cable network to which connections for a television set TV, a computer PC and a telephone Tel are illustrated.

The area located between the end subscribers and the central unit is normally designated as network level 4, NL4. The area above it, insofar as the distribution of television programmes is concerned, is designated as network level 3, NL3.

At least network level 4, NL4, is currently designed with coaxial cables as a cable distribution system. It is assumed and also supposed for the present invention that this also continues to be so. The transition to glass fiber networks in this area should not be ruled out. Network level 4, NL4, is currently typically in the hands of smaller operators, such as house-owner groups, housing estate associations or local trade companies. Operators of this kind often have their own aerial system, which they then use as a television head station TVHE. In these cases network level 3, NL3, is not necessary. However, these operators normally have no direct access to public communications networks.

According to the invention communications services are connected at the transition between network level 3, NL3, and network level 4, NL4. At a distribution or interconnection point, which is usually there in any case, a frequency separating filter FS and a network termination unit NT are now additionally fitted in to make this point into a central unit CU according to the invention. A communications service is now connected via radio by this network termination unit NT. For this purpose the radio base station RBS is connected to the public communications network CN. The central unit CU is allocated a radio network termination unit RT, which is connected to the network termination unit NT of this central unit CU.

The radio base station of a cell of a cellular radio communications service is provided here according to the invention as radio base station. It is therefore provided that the resources of this radio base station are not permanently allocated to this one radio network termination unit RT, but are assigned according to a predetermined protocol depending on requirement.

Various radio communications services of this kind are already known. Without going into further details, reference is made here to the following known services or systems: GSM, DECT, UMTS. A particularly suitable service here is LMDS (Local Multipoint Distribution Service). This service is described, for example, in “LMDS Systems and their Application” by Agne Nordbotten in IEEE Communications Magazine, June 2000, on pages 150-154. A system of this kind and the service associated with it is particularly tailored to broadband house connections, in other words to distances in the range of up to several kilometers, and stationary applications. It operates in the frequency range of approximately 30 GHz with a transmission capacity of approximately 30 Mbit/s. Basically, though, the other systems mentioned are equally usable, with certain restrictions, as also the use of systems which have not yet been developed is not ruled out. The optical range can also basically not be ruled out as “radio area”, even if no optical point-to-multipoint systems are currently known.

The respective base station of a system of this kind is not covered by the present invention.

On the subscriber side the functions are divided up, however. This is explained in greater detail using FIG. 2. This shows an excerpt from FIG. 1 with more details and partially also additional devices.

FIG. 2 shows a cable distribution system CDS, which on the one hand is connected to the central unit CU and on the other hand to the premises UP of a consumer. The cable distribution system CDS is illustrated here simply as a branch of a line coming from the central unit CU. In general this is a network with a tree structure.

The central unit CU has in this example the network termination unit NT, a format converter FC, the frequency separating filter FS and an optional signal path with a filter unit FU. A functional, but not structural, component of the central unit CU is the radio termination unit RT. This radio termination unit RT in turn forms a functional unit with the network termination unit NT, here designated as termination unit TU.

In the premises UP of a consumer a cable branch is illustrated here, to the ends of which in one case a television set TV, in one case a connection unit AU, in one case a communications terminal TE and in one case a computer PC are connected. It is assumed that distribution is carried out correctly in the usual way, in particular matched as regards impedance.

The television set TV remains unaffected by the present invention. It will possibly be able to receive the signals of the communications service in one of its frequency channels and convert them into the basic frequency, but it will not be able to demodulate these signals.

In order to be able to understand the function of the connection unit AU, a complete signal path of the signals of a communications service must now be looked at. The signal path from the public communications network CN to the consumer (end subscriber) is therein primarily looked at. The reverse path runs completely analogously, though the capacities allocated for the two paths are different.

A trunk group of data streams is transmitted simultaneously in a way known per se from the public communications network CN via the radio base station RBS and the termination unit TU. On the side of the public communications network CN and the radio base station RBS nothing changes owing to the present invention. The radio termination unit RT is an input amplifier with frequency conversion connected to an aerial and generally also combined with it structurally. The intermediate frequency, into which conversion takes place, is in the range of approximately 1 GHz. The adjoining network termination unit NT on the one hand converts into the basic band range and on the other hand applies the rules of the protocol used, in order again to output at its output the trunk group of data streams, for example in the known ethernet format. In the simplest case this signal can be guided as a basic band signal via the cable distribution system to the connection unit AU and to the other connected devices. At the feed-in point of the television programme signals, here the frequency separating filter FS, it must be ensured that the data streams are not also fed back to there. In the simplest case a high-pass filter in the direction of network level 3, NL3, can be sufficient for this. Simple connection of the two signal paths is not sufficient at this point. It is vital that the switching unit required here separates the two connections pointing away from the cable distribution system from one another.

In most cases, however, transmitters are used for matching impedance at the branching points, whereby only signals free of direct current, in other words not those in the basic band, can be transmitted. For this reason, among others, the trunk group of data streams is preferably converted into an otherwise unused television channel or into several connected television channels. It is therein quite possible for television signals to be converted first into other channels, in order always to be able to treat the trunk group of data streams in the same way. The format converter FC in the central unit and a corresponding format converter FC′ in the connection unit AU serve this purpose. In the central unit CU the frequency separating filter FS must be correspondingly structured for this. Appropriate filters emerge for the person skilled in the art in a known way. The sum of all the properties, such as standards, frequencies, signal formats and such, which have to be included in order to be able to transmit the actual useful contents of the signal, should be regarded as “format” or else “protocol”. The term “interface” should also be similarly regarded.

According to the invention it is also provided to convert this trunk group of data streams in the connection unit AU into the protocol of a wire-bound communications service. ISDN is currently the most likely for Germany. In the case of conversion to ISDN this connection unit AU could, as normal in such cases, have two S-zero interfaces. The connection unit AU could then also be extended to a domestic telephone exchange, which possibly has several connections for analog telephone or, for example, fax machines or for connecting a DECT base station. A base station of this kind could also be part of the connection unit AU itself. There could also be a USB port in this case for connecting a computer or a “Bluetooth” interface.

Instead of a connection unit AU of this kind a communications terminal TE is connected to another end of the cable branch in the premises UP of this consumer. This communications terminal TE is a simple version of a combination of a connection unit and a terminal connected to it. Here, by contrast with connection unit AU, not only a format converter FC′, but also a filter unit FU′ is drawn in. As here still only band-limited signals can be converted in the frequency, it is vital that the required filter function is ensured in some way or other.

Finally, a computer PC with integrated connection unit is connected to a further end of the cable branch in the premises UP of this consumer. Integration of any sort of hardware components into a computer takes place in the normal way and here too by using a plug-in board PIB, which has a standardized interface towards the “mainboard” or “motherboard” of the computer and an application-specific interface towards the outside, here in other words a connection to the internal house cable network.

If the cable distribution system CDS happens not to be structured purely passively, it must be ensured that the signals additionally used here are not impaired by the active parts. In the simplest case they can be bridged by passive filters. It is vital that it is taken into account that signals are now transmitted in both directions, even though in the preceding description substantially only the direction from the public network to the consumers has been described in detail.

In the central unit CU an optional signal path with a filter unit FU is also drawn in. This can be used if the central unit, which has to be located at the output point of the cable distribution system CBS structured like a tree, is located unsuitably for receipt of the signals coming from the radio base station, for example because the television programme signals come from a cable television system laid in the ground. In this case it is advisable to use the cable distribution system CDS for connecting between the radio termination unit RT and the central unit CU. This presupposes that a sufficiently broad frequency range is still free and is separated in the central unit CU and in some circumstances also at the connection to the radio termination unit RT by one filter unit FU in each case.

Each device suitable for offering communications services can automatically also offer such services as per se are directed to one side only and in which the opposite direction is used at the same time only for control. In the present example there is so much capacity that it is quite possible also to transmit television programmes via the communications service. As a final consequence the television distribution system can therefore be dispensed with. In this way the corresponding components and modules required only for correct cooperation between the television distribution system and the devices of the communications services also become unnecessary.

Still remaining are the devices for carrying out communications services, which firstly, at the end of the access range remote from the subscriber, have at least one cell of a cellular radio communications service, to which a cable distribution system connects at the end near the subscriber. It should therein not be ruled out that, as by no means unusual today, at least individual terminals are again connected via radio.

It should in conclusion also be pointed out that the invention can also be composed largely of components which are already known and are partially available on the market. For example, insertion and extraction of the data streams into or out of the cable distribution system can take place by means of so-called cable modems. The central unit CU then consists substantially of, for example, an LMDS connection unit and a cable modem.

1. System for distributing television programmes with a television distribution system operated like a radio broadcast and at least one cable distribution system for connecting a plurality of television sets, with a central unit connecting the distribution system to the television distribution system, wherein at least one cell of a cellular radio communications service is present and is connected to the central unit of the distribution system via a connection unit, for carrying out communications services.

2. Central unit of a distribution system with a connector for a television distribution system and at least one connector for a cable distribution system for connecting a plurality of television sets, wherein the central unit includes a switching unit which is suitable for feeding signals from and for a connection unit of a cellular radio communications service, in addition to the signals of the television distribution system, into the cable distribution system or to extract them from it.

3. Central unit according to claim 2, wherein a network termination unit is part of the central unit, wherein the network termination unit together with a radio termination unit represents a connection unit of a cellular radio communications service.

4. Central unit according to claim 2, wherein it includes a filter unit, in order to extract signals from the signals of the cable distribution system and to insert others into it, which come from a network termination unit of a cellular radio communications service or are intended for it.

5. Central unit according to claim 3, wherein it includes a format converter between the network termination unit and the switching unit.

6. Communications terminal for connection to a cable distribution system in the system according to claim 1, wherein the communications terminal includes a format converter for separating signals of a cellular radio communications service.

7. Plug-in board for a computer for connecting to a cable distribution system in the system according to claim 1, wherein the plug-in board has a format converter for separating signals of a cellular radio communications service.

8. Connection unit for connecting to a cable distribution system in the system according to claim 1, wherein the connection unit includes a format converter for separating signals of a cellular radio communications service and further a protocol converter for converting the signals of a cellular radio communications service into signals of a wire-bound communications service, in particular into ISDN or DSL signals.

9. System with a cable distribution system and a central unit terminating the distribution system at the end remote from the subscriber, wherein a cell of a cellular radio communications service is present and is connected to the central unit of the distribution system via a connection unit.

10. Central unit of a distribution system with at least one connector for a cable distribution system, wherein a network termination unit is part of the central unit, wherein the network termination unit together with a radio termination unit represents a connection unit of a cellular radio communications service.
